(19) United States
(12) Patent Application Publication
(10) Pub. No.: US 2010/0194227 A1
(43) Pub. Date: Aug. 5, 2010

(54) POWER GENERATOR

(75) Inventor: Tetsuo Okamoto, Ehime (JP)

Correspondence Address: RABIN & Berdo, PC, 1101 14TH STREET, NW, SUITE 500, WASHINGTON, DC, 20005, US

(73) Assignees: Norimasa Okamoto, Chiba (JP); Kouji Nitta, Kanagawa (JP)

(21) Appl. No.: 12/676,923

(22) PCT Filed: Oct. 5, 2007
(86) PCT No.: PCT/JP2007/069606

§ 371 Date: Mar. 8, 2010

(51) Int. Cl. H02K 21/24

(52) U.S. Cl. 310/156.37

(57) ABSTRACT

A power generator produces electromotive forces in the same direction on all windings to prevent lowering of rotational forces of rotor plates due to magnetic fields. The generator includes first windings divided in plural number and wound around a fixed ring core in opposite directions. Second windings having the same constitution as the first windings are wound at 45° to the first windings. Capacitors are connected to one end of each of the first and second windings. A first rotor plate having first permanent magnets is provided on one surface of the ring core and a second rotor plate having second permanent magnets is provided on the opposite surface of the ring core. The two rotor plates are provided on a driving shaft so that the same magnetic poles thereof oppose each other and rotate to output electricity generated on the first and second windings via the capacitors.

### TECHNICAL FIELD

The present invention relates to a generator which generates electricity by rotating permanent magnets with rotational forces applied from outside. More specifically, the present invention relates to a generator which directs electromotive forces of windings in the same direction and adjusts phases of the electromotive forces to prevent occurrence of counter-rotating torque, thereby increasing electricity generation efficiency.

### BACKGROUND ART

Patent Document 1 describes a generator which generates electricity by rotating permanent magnets with rotational forces applied from outside. In FIG. 4a, the generator (100) includes a left rotor plate (5L) and a right rotor plate (5R) on both sides of a stator (10) held by a stator case (20). A semicircular permanent magnet (6NL) magnetized in the direction opposed to the stator (10) is adhered to the left rotor plate (5L) in such a manner that the North pole faces toward the stator (10). A semicircular permanent magnet (6SL) magnetized in the direction opposed to the stator (10) is adhered to the left rotor plate (5L) in such a manner that the South pole faces toward the stator (10). Similarly, a semicircular permanent magnet (6NR) magnetized in the direction opposed to the stator (10) is adhered to the right rotor plate (5R) in such a manner that the North pole faces toward the stator (10). Further, a semicircular permanent magnet (6SR) magnetized in the direction opposed to the stator (10) is adhered to the right rotor plate (5R) in such a manner that the South pole faces toward the stator (10).

In FIG. 4b, the stator (10) has toroidally wound windings (L1) to (L12) around a ring core (11) at an equal angle. A hole sensor 12 is provided between the windings (L12) and (L1). In FIG. 5, the windings (L1) to (L6) are connected in series via rectifiers (D1) to (D5). The winding (L6) is connected to a first end of a first TRIAC (T1) via a rectifier (D6). The windings (L7) to (L12) are connected in series via rectifiers (D7) to (D11). The winding (L12) is connected to a first end of a second TRIAC (T2) via a rectifier (D12). The rectifiers (D1 to D12) have storage circuits (H1 to H12), respectively. Second ends of the first and second TRIACs (T1 and T2) are connected to a capacitor (C) via current suppression resistances R1 and R2.

When the left rotor plate (5L) and the right rotor plate (5R) are rotated, the polarity of a magnetic flux detected by the hole sensor (12) is inverted from the South pole to the North pole so that the first TRIAC (T1) is turned on and the second TRIAC (T2) is turned off. When the left rotor plate (5L) and the right rotor plate (5R) are further rotated, electromotive forces in the forward direction of the rectifiers (D1) to (D6) are produced on the windings (L1) to (L6) so as to charge the storage circuits (H1) to (H6). At this time, the voltages of the storage circuits (H1) to (H6) are added. The capacitor (C) is charged by the voltage of the storage circuit (H6) via the first TRIAC (T1) and the current suppression resistance (R1) to output a direct current from both ends of the capacitor (C).

When the left rotor plate (5L) and the right rotor plate (5R) are further rotated, the polarity of a magnetic flux detected by the hole sensor (12) is inverted from the

North pole to the South pole causing the first TRIAC (T1) being turned off and the second TRIAC (T2) being turned on. When the left rotor plate (5L) and the right rotor plate (5R) are further rotated, electromotive forces in the forward direction of the rectifiers (D7) to (D12) are produced on the windings (L7) to (L12) to charge the storage circuits (H7) to (H12), and the voltages of the storage circuits (H7) to (H12) are added. The capacitor (C) is charged by the voltage of the storage circuit (H12) via the second TRIAC (T2) and the current suppression resistance (R2) to output a direct current from both ends of the capacitor (C).

As described above, a magnetic field is generated on the left rotor plate (5L) from the permanent magnets (6NL) to (6SL); a magnetic field is generated on the right rotor plate (5R) in a direction from the permanent magnets (6NR) to (6SR); and the left rotor plate (5L) and the right rotor plate (5R) are rotated to produce in-phase and anti-phase electromotive forces with each other on the windings (L1) to (L6) and the windings (L7) to (L12). There has been problem that when electricity is taken out from the windings (L1) to (L6) of the toroidal windings (L1) to (L12) of the ring core (11) of the stator (10), it cannot be taken out from the windings (L7) to (L12).

The hole sensor (12), the first TRIAC (T1), and the second TRIAC (T2) need to be provided to cut the anti-phase electromotive force, thereby accompanying a circuit load. Occurrence of counter-rotating torque due to the electromotive forces produced on the respective windings causes to lower the rotational forces of the rotor plates and electricity generation efficiency.

[Patent Document 1] Japanese Patent Publication No. 3783141

### DISCLOSURE OF THE INVENTION

### Problems to be Solved by the Invention

The present invention has been made to solve such problems and an object of the present invention is to provide a generator which produces electromotive forces in the same direction on all windings and prevents occurrence of counter-rotating torque due to the electromotive forces to offer high efficiency with low circuit loads.

### Means for Solving the Problems

A generator of the present invention has a fixed ring core having first windings wound around, and first and second rotor plates provided on a driving shaft to be opposed to each other having the ring core therebetween, wherein a plurality of permanent magnets are provided on the opposite surfaces of the first and second rotor plates in such a manner that magnetic poles of the plurality of permanent magnets are arrayed alternatively so as to be different with each other, and the first and second rotor plates are provided on the driving shaft in such a manner that the same magnetic poles of the arrayed plurality of permanent magnets thereof are opposed to each other, and wherein the first windings are divided in the plural number and wound around the ring core so that the winding directions of the divided windings are opposed to each other, and one end of the first windings is connected with a capacitor.

In the generator of the present invention, the number of the permanent magnets of the first and second rotor plates is equal to the number of division of the first windings.

In the generator of the present invention, second windings having the identical constitution with that of the first windings are wound over the first windings in such a manner that a winding start portion of the second windings is displaced by 45 degrees from the winding start portion of the first windings.

### Advantages of the Invention

According to the generator of the present invention, it is possible to produce electromotive forces in the same direction on all windings and prevent occurrence of counter-rotating torque due to the electromotive forces, thereby it is possible to provide a generator which offers high efficiency without any circuit loads.

### BRIEF DESCRIPTION OF THE DRAWINGS

FIGS. 1a and 1b are block diagrams showing the constitution of a generator of the present invention;

FIGS. 2a and 2b are exploded views of windings of a ring core of the present invention;

FIGS. 3a and 3b are array block diagrams of a permanent magnet of the present invention;

FIGS. 4a and 4b are a front view and a side view of a conventional generator; and

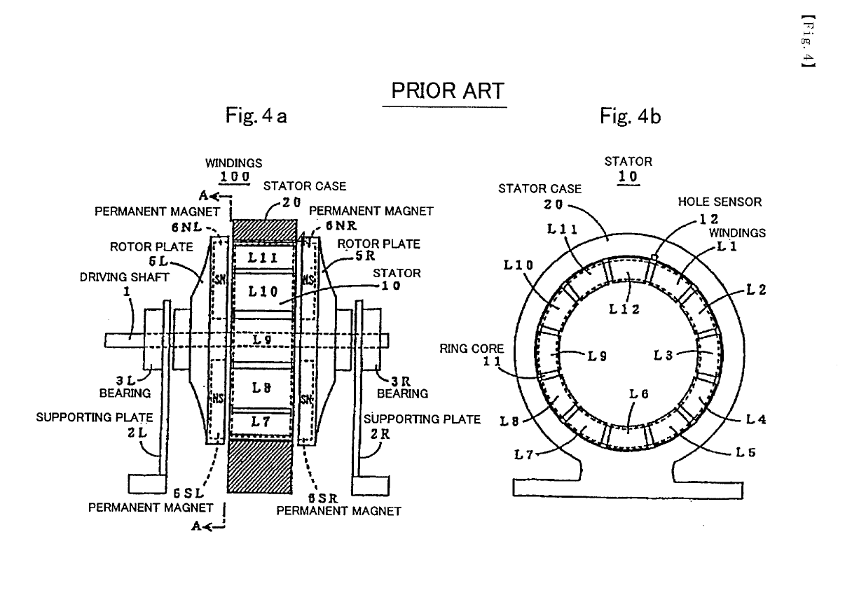

FIG. 5 is a circuit diagram showing electric connection of the conventional generator.

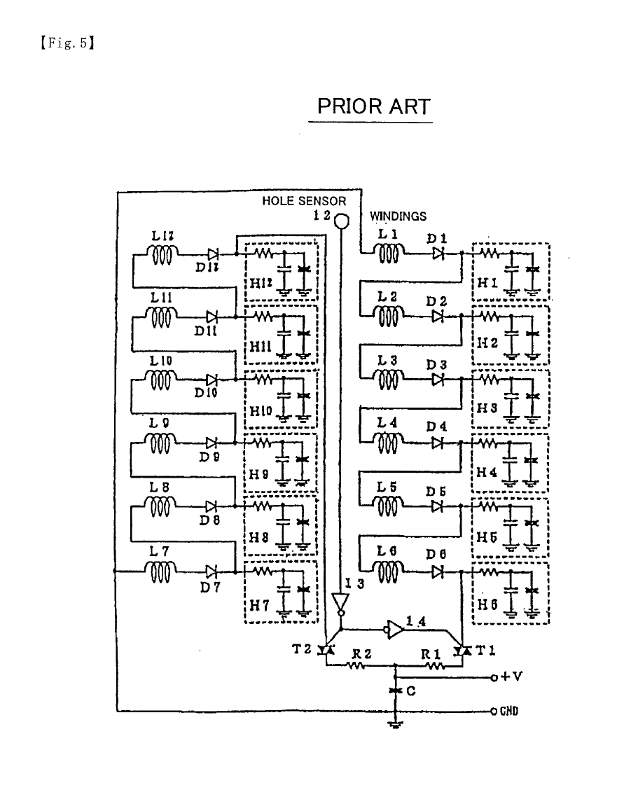

### DESCRIPTION OF SYMBOLS

5: ring core

15-1 to 15-4: first winding

25-1 to 25-4: second winding

30: first rotor plate

35: second rotor plate

40-1 to 40-4: first permanent magnet

45-1 to 45-4: second permanent magnet

50: driving shaft

60: stator

70-1 and 70-2: bearing

75-1 and 75-2: supporting plate

80-1 and 80-2: capacitor

90: base

92-1 and 92-2: winding start portion

110: generator

### BEST MODE FOR CARRYING OUT THE INVENTION

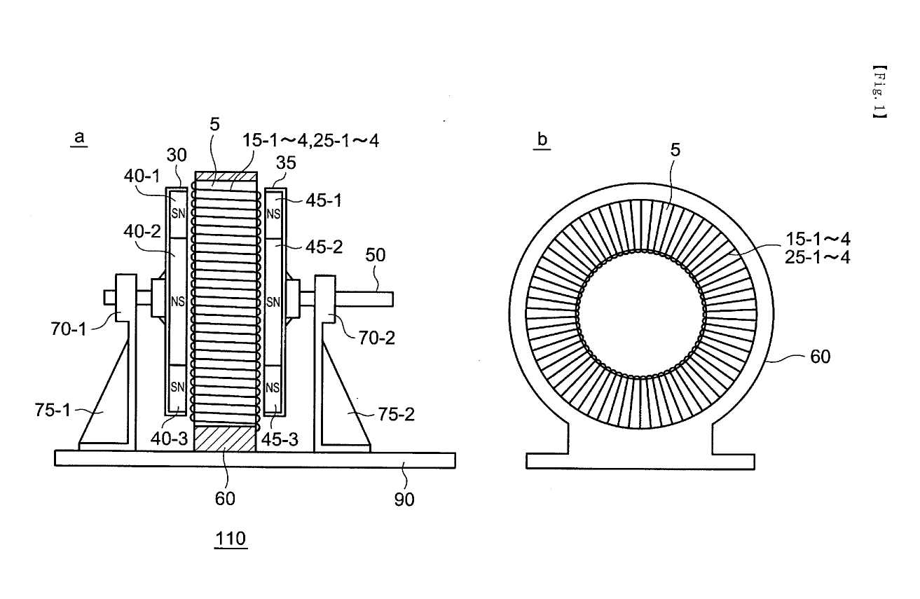

An embodiment of the present invention will be described with reference to the drawings. FIGS. 1a and 1b are block diagrams showing the constitution of a generator of the present invention. In FIG. 1a, a stator 60 of a generator 110 is fixed onto a base 90 and a ring core 5 around which first windings 15-1 to 15-4 and second windings 25-1 to 25-4 are wound is provided in the stator 60. A first rotor plate 30 and a second rotor plate 35 are provided on bearings 70-1 and 70-2 having supporting plates 75-1 and 75-2 via a driving shaft 50, and the bearings 70-1 and 70-2 are fixed onto the base 90. The first rotor plate 30 and the second rotor plate 35 have first permanent magnets 40-1 to 40-4 and second permanent magnets 45-1 to 45-4, respectively. The driving shaft 50 obtains rotation driving torque from outside (not shown), and rotates the first rotor plate 30 and the second rotor plate 35 to generate rotation magnetic fields.

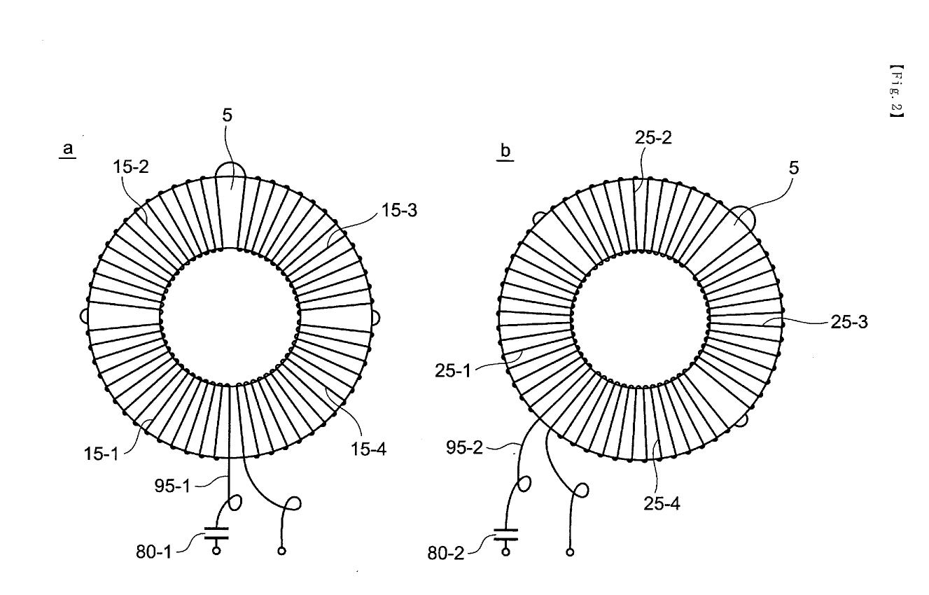

In FIG. 1b, the ring core 5 around which the first windings 15-1 to 15-4 and the second windings 25-1 to 25-4 are wound is fitted into the stator 60. FIGS. 2a and 2b are winding exploded views of the ring core explaining in more detail the state that the first windings 15-1 to 15-4 and the second windings 25-1 to 25-4 are wound around the ring core 5 of FIG. 1b. In FIG. 2a, the first windings 15-1 to 15-4 are arranged at an angle of 90 degrees to each other, and are wound around the ring core 5 in such a manner that the first windings 15-1 and 15-3 are opposed to each other and the first windings 15-2 and 15-4 are opposed to each other. The first windings 15-1 and 15-3 are wound in the direction opposed to that of the first windings 15-2 and 15-4. An end of a winding start portion 95-1 of the first winding 15-1 is connected with a capacitor 80-1.

In FIG. 2b, the second windings 25-1 to 25-4 are arranged at an angle of 90 degrees to each other, the second windings 25-1 and 25-3 are opposed to each other, and the second windings 25-2 and 25-4 are opposed to each other. A winding start portion 95-2 of the second windings starts to be wound at the displacement of 45 degrees with respect to the winding start portion 95-1 of the first windings, and the second windings are wound over the first windings 15-1 to 15-4. The second windings 25-1 to 25-4 are wound in the same direction as that of the first windings 15-1 to 15-4. An end of the winding start portion 95-2 of the second winding 25-1 is connected with a capacitor 80-2.

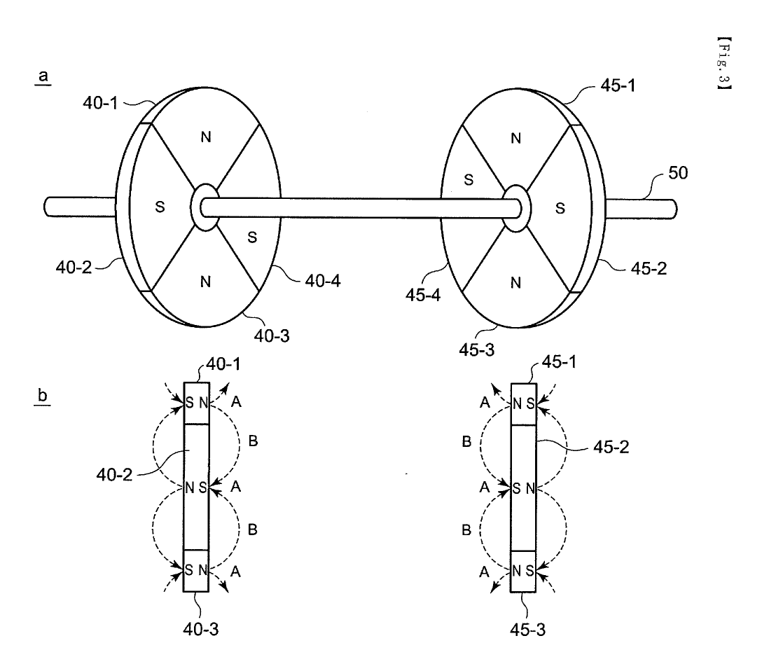

FIGS. 3a and 3b are array block diagrams explaining in more detail the array of first and second permanent magnets provided on the first and second rotor plates, respectively. However, the first rotor plate 30 and the second rotor plate 35 connected to the driving shaft 50 in FIG. 1a are omitted. In FIG. 3a, the first permanent magnets 40-1 to 40-4 are arrayed at an angle of 90 degrees to each other, and are provided on the first rotor plate 30 in such a manner that the first permanent magnets 40-1 and 40-3 are opposed to each other and the first permanent magnets 40-2 and 40-4 are opposed to each other. Similarly, the second permanent magnets 45-1 to 45-4 are arrayed at an angle of 90 degrees to each other, and are provided on the second rotor plate 35 in such a manner that the second permanent magnets 45-1 and 45-3 are opposed to each other and the second permanent magnets 45-2 and 45-4 are opposed to each other. The first permanent magnets 40-1 and 40-3 of the first rotor plate 30 have surfaces having the same magnetic pole, which is the North pole in this figure, as that of the corresponding opposite surfaces of the second permanent magnets 45-1 and 45-3 of the second rotor plate 35. The first permanent magnets 40-2 and 40-4 have surfaces having the other same magnetic pole, which is the South pole, as that of the corresponding opposite surfaces of the second permanent magnets 45-2 and 45-4. The respective permanent magnets may be arrayed with a space therebetween as long as they keep an angle of 90 degrees to each other, and may not be arrayed in close contact with each other.

FIG. 3b shows side surfaces of the arrayed first and second permanent magnets when viewed from a viewer's side of the drawing. Magnetic fluxes coming out from the North poles of the opposite surfaces of the first permanent magnets 40-1 and 40-3 and the second permanent magnets 45-1 and 45-3 enter the South poles of themselves and the first permanent magnets 40-2 and 40-4 and the second permanent magnets 45-2 and 45-4, respectively, thereby forming magnetic path. Similarly, the magnetic fluxes coming out from the North poles of the other surface opposed to the opposite surfaces of the first permanent magnets 40-2 and 40-4 and the second permanent magnets 45-2 and 45-4 enter the South poles of themselves and the first permanent magnets 40-1 and 40-3 and the second permanent magnets 45-1 and 45-3, respectively, thereby forming the magnetic path. In the figure, A represents a portion where the magnetic flux is dense, while B represents a portion where the magnetic flux is less dense.

Referring again to FIGS. 1a and 1b, when the driving shaft 50 is rotated by obtaining the rotation driving torque from outside, the first rotor plate 30 and the second rotor plate 35 are rotated as well to render the magnetic fluxes generated on the opposite surfaces in FIG. 3b to be the rotation magnetic fields, thereby producing electromotive forces on the first windings 15-1 to 15-4 and the second windings 25-1 to 25-4. As explained in FIG. 2, the winding directions of the first windings 15-1 to 15-4 and the second windings 25-1 to 25-4 are opposed to each other, so that the change in the direction of the magnetic fluxes generated at the North poles in FIG. 3b to the opposite direction due to returning to themselves and the adjacent South poles and the change in the direction of the windings occur in synchronization with the rotation. Accordingly, the alternating electromotive forces produced on the respective windings are always in the same phase, and do not cancel each other. For this reason, it becomes possible to provide the generator without any circuit loads for cutting the anti-phase electromotive forces. In this case, the alternating electromotive forces having the phases displaced at an angle of 45 degrees to each other are produced on the first windings and the second windings. The first rotor plate 30 and the second rotor plate generally receive counter-rotating torque due to currents and the magnetic fluxes caused by the produced electromotive forces. However, the respective phases of their alternating currents caused by the produced electromotive forces are advanced by 90 degrees by the capacitors 80-1 and 80-2. Thereby, each winding runs through the portion B, where the magnetic flux is less dense, when the peak alternating current is flowing through each winding, so that the direction of the winding becomes parallel to the magnetic flux and thus the magnetic flux is not cut. For this reason, the force in the direction opposed to the rotation is not produced. Although each winding runs through the portion A, where the magnetic flux is dense, when the alternating current is not flowing through each winding and thus the magnetic flux is cut, the force in the direction opposed to the rotation is not produced because the current is not flowing therethrough. For this reason, the rotation driving torque obtained from outside is transmitted to the first rotor plate 30 and the second rotor plate 35 without being impaired, so that it becomes possible to obtain the generator which offers high electricity generation efficiency.

### INDUSTRIAL APPLICABILITY

As described above, according to the present invention, electromotive forces in the same phase can be produced on all windings, which eliminates the need of electronic circuits for cutting the electromotive forces in the opposite direction and allows for providing a generator with simple circuits. Moreover, an alternating current flowing through the windings caused by the alternating electromotive forces is advanced in phase by 90 degrees by a capacitor and thus not generate counter-rotating torque, so that rotation driving torque from outside is not impaired and it becomes possible to provide the generator which offers high electricity generation efficiency.

1. A generator comprising: a fixed ring core having first windings wound around; and first and second rotor plates provided on a driving shaft to be opposed to each other having said ring core therebetween, wherein
a plurality of permanent magnets are provided on the opposite surfaces of said first and second rotor plates in such a manner that magnetic poles of said plurality of permanent magnets are arrayed alternatively so as to be different with each other, and said first and second rotor plates are provided on said driving shaft in such a manner that the same magnetic poles of said arrayed plurality of permanent magnets thereof are opposed to each other, and
said first windings are divided in the plural number and wound around said ring core so that the winding directions of the divided windings are opposed to each other, and one end of said first windings is connected with a capacitor.

2. The generator according to claim 1, wherein the number of said permanent magnets of said first and second rotor plates is equal to the number of division of said first windings.

3. The generator according to claim 2, wherein second windings having the identical constitution with that of said first windings are wound over said first windings in such a manner that a winding start portion of said second windings is displaced by 45 degrees from the winding start portion of said first windings.

4. The generator according to claim 1, wherein second windings having the identical constitution with that of said first windings are wound over said first windings in such a manner that a winding start portion of said second windings is displaced by 45 degrees from the winding start portion of said first windings.
